(19) United States
(12) Patent Application Publication
(10) Pub. No.: US 2025/0001428 A1
(43) Pub. Date: Jan. 2, 2025

(54) ROTOR ASSEMBLY FOR A PULVERIZER AND PULVERIZER COMPRISING THE SAME

(71) Applicant: TORXX KINETIC PULVERIZER LIMITED, Hamilton (BM)

(72) Inventors: Jaroslaw Lutoslawski, Hamilton (BM); Clint Aldridge, Fayette, AL (US); Christopher Mueller, Hamilton (BM)

(73) Assignee: TORXX KINETIC PULVERIZER LIMITED, Hamilton (BM)

(21) Appl. No.: 18/836,709

(22) PCT Filed: Feb. 10, 2022
(86) PCT No.: PCT/CA2022/050197

§ 371 Date: Aug. 7, 2024

(51) Int. Cl. B02C 13/18; B02C 13/28

(52) U.S. Cl. CPC B02C 13/18; B02C 13/2804; B02C 2013/2808

(57) ABSTRACT

A rotor assembly for a pulverizer, the pulverizer including a housing and a rotatable shaft rotatably mounted in the housing, the rotor assembly comprising: a hub mountable on the rotatable shaft; a plurality of rotor arms extending outwardly from the hub for pulverizing material received in the housing when the rotatable shaft is rotated; wherein the hub including a plurality of hub sections connectable together to form the hub, the hub sections being separable from each other and movable radially outwardly away from the rotatable shaft.

### TECHNICAL FIELD

The technical field generally relates to pulverizers and/or vertical mills, and more specifically to rotor assemblies for pulverizers and to pulverizers comprising rotor assemblies. The technical field further pertains to methods for removing a rotor assembly from a pulverizer.

### BACKGROUND

Pulverizing apparatuses, or “pulverizers”, have been used for pulverizing, separating, aerating and/or homogenizing solid materials such as waste material. Pulverizers are sometimes used in certain industrial transformation operations to reduce the particle size of an input material such as ore or the like.

Pulverizers typically include a housing, a rotatable shaft disposed vertically in the housing and one or more rotor assemblies mounted on the rotatable shaft. Usually, each rotor assembly includes a rotor hub engaging the rotatable shaft and a plurality of rotor arms extending outwardly from the rotor hub. Material is introduced in the housing through an inlet of the housing, is pulverized by the rotation of the shaft and rotor assemblies, and the pulverized material is discharged through an outlet of the housing.

For various reasons, it may be desirable or necessary to remove one or more of the rotor hubs from the rotatable shaft when the pulverizer is not in operation. For example, it may be desirable or necessary to perform maintenance on the rotor hubs, on the rotatable shaft or on the interior of the housing. It may also be desirable or necessary to replace part of the rotor hubs, such as one or more rotor arms of the rotor hubs, or one or more entire rotor hubs if the hubs are damaged, worn or to accommodate a different input material. It could also be desirable or necessary to disassemble part of the pulverizer or the entire pulverizer, for example to facilitate transportation of the pulverizer or to dispose of the pulverizer.

In some instances, the rotor hubs could be removed from the rotatable shaft by sliding the rotor hub along the shaft towards a top end of the shaft. However, it may not be possible or practical to remove the rotor hubs in this manner. For example, in some pulverizers, the top and bottom ends of the rotatable shaft are secured to ceiling and floor plates of the housing. This configuration would require the ceiling or floor plates to be removed to slide off the rotor hubs from one of the ends of the shaft.

It may therefore be desirable to provide a pulverizer and a rotor assembly for the pulverizer that would overcome or alleviate at least one of the above-identified drawbacks.

### SUMMARY

According to one aspect, there is provided a rotor assembly for a pulverizer, the pulverizer including a housing and a rotatable shaft rotatably mounted in the housing, the rotor assembly comprising: a hub mountable on the rotatable shaft; a plurality of rotor arms extending outwardly from the hub for pulverizing material received in the housing when the rotatable shaft is rotated, wherein the hub including a plurality of hub sections connectable together to form the hub, the hub sections being separable from each other and movable radially outwardly away from the rotatable shaft.

In at least one embodiment, the plurality of hub sections includes two hub sections.

In at least one embodiment, the hub sections are disconnectable from each other by moving the hub sections relative to each other in a direction parallel to an axis of the rotatable shaft.

In at least one embodiment, each hub section includes at least one hub section connector, each hub section connector being adapted to engage a corresponding hub section connector of another one of the hub sections.

In at least one embodiment, each hub section connector includes one of a male hub section connector and a female hub section connector.

In at least one embodiment, each hub section includes first and second hub section ends, the first hub section end including a male hub section connector and the second hub section end including a female hub section connector.

In at least one embodiment, the male and female hub section connectors form a dovetail connection.

In at least one embodiment, the male hub section connector includes a narrow base portion and a flared end portion extending away from the narrow base portion, the flared end portion being wider than the narrow base portion.

In at least one embodiment, the female hub section connector includes a narrow neck portion and a flared inner portion extending away from the narrow neck portion and into the corresponding hub section, the flared inner portion being wider than the narrow neck portion.

In at least one embodiment, the rotor hub includes upper and lower hub plates spaced apart from each other and extending substantially parallel to each other, and an annular core member coaxially engageable with the rotatable shaft and disposed between the upper and lower hub plates.

In at least one embodiment, a portion of the rotor arms is disposed between the upper and lower hub plates.

In at least one embodiment, the rotor hub further includes a plurality of plate spacers extending between the upper and lower hub plates.

13. The rotor assembly as claimed in claim 12, wherein each plate spacer includes a cylindrical barrel extending perpendicularly to the upper and lower hub plates for receiving a fastener extending through the cylindrical barrel and through the upper and lower hub plates.

In at least one embodiment, the annular core member is substantially polygonal and defines a plurality of corners, the annular core member further including a plurality of fastener openings, each fastener opening being located at one of the corners of the annular core member.

In at least one embodiment, the annular core member is substantially octagonal.

In at least one embodiment, the annular core member includes a main body having top and bottom core member surfaces, a top circular projection extending away from the top core member surface and a bottom circular projection extending away from the bottom core member surface.

In at least one embodiment, the top and bottom core member surfaces are substantially planar and extend substantially parallel to each other.

In at least one embodiment, the upper hub plate has a central plate opening, the upper hub plate being receivable on the top core member surface such that the top circular projection is received in the central plate opening of the upper hub plate.

In at least one embodiment, the central plate opening of the upper hub plate has a diameter which is substantially equal to an outer diameter of the top circular projection such that the top circular projection snuggly fits in the central plate opening of the upper hub plate.

In at least one embodiment, the lower hub plate has a central plate opening, the lower hub plate being receivable on the bottom core member surface such that the bottom circular projection is received in the central plate opening of the lower hub plate.

In at least one embodiment, the central plate opening of the lower hub plate has a diameter which is substantially equal to an outer diameter of the bottom circular projection such that the bottom circular projection snuggly fits in the central plate opening of the lower hub plate.

In at least one embodiment, the rotor hub further includes top and bottom retaining rings coaxially engaging the rotatable shaft and positioned on either side of the upper and lower hub plates.

In at least one embodiment, each one of the top and bottom retaining rings is substantially flat and has an inner diameter substantially equal to a diameter of the rotatable shaft.

In at least one embodiment, the top retaining ring has an outer diameter greater than an outer diameter of the top circular projection of the annular core member so as to overlap both the top circular projection and the upper hub plate when in abutment with the upper hub plate.

In at least one embodiment, the bottom retaining ring has an outer diameter greater than an outer diameter of the bottom circular projection of the annular core member so as to overlap both the bottom circular projection and the lower hub plate when in abutment with the lower hub plate.

In at least one embodiment, the top retaining ring includes a first plurality of fastener-receiving openings and the bottom retaining ring includes a second plurality of fastener-receiving openings alignable with the first plurality of fastener-receiving openings to allow the top and bottom retaining rings to be connected together using a plurality of fasteners engaging corresponding fastener-receiving openings of the first and second pluralities of fastener-receiving openings and corresponding fastener openings of the annular core member.

In at least one embodiment, the rotor assembly further comprises a hub locking member selectively engageable with the rotor hub to secure the rotor hub at a desired axial location along the rotatable shaft.

In at least one embodiment, the locking member includes a ring member coaxially engageable with the rotatable shaft, the ring member being engageable with both the hub and the rotatable shaft to prevent movement of the hub relative to the rotatable shaft.

In at least one embodiment, the ring member includes an annular wall having top and bottom ends and a top flange located at the top end, the annular wall being wedgeable between the hub and the rotatable shaft to prevent movement of the hub relative to the rotatable shaft.

In at least one embodiment, the annular wall has a cylindrical inner surface for engaging the rotatable shaft.

In at least one embodiment, the ring member is penannular and includes first and second ring ends which are spaced apart from each other.

In at least one embodiment, the ring member is substantially resilient to allow movement of the first and second ring ends towards each other.

In at least one embodiment, the annular wall has a tapered outer surface slidable against a corresponding angled inner surface of the hub when the ring member is moved along the rotatable shaft and towards the hub to move the first and second ring ends towards each other.

According to another aspect, there is also provided a shaft assembly for a pulverizer, the pulverizer including a housing, the shaft assembly comprising: a rotatable shaft rotatably mountable in the housing; a hub mountable on the rotatable shaft; a plurality of rotor arms extending outwardly from the hub for pulverizing material received in the housing when the rotatable shaft is rotated, wherein the hub including a plurality of hub sections connectable together to form the hub, the hub sections being separable from each other and movable radially outwardly away from the rotatable shaft.

According to yet another aspect, there is also provided a pulverizer comprising: a housing; a rotatable shaft rotatably mountable in the housing; a hub mountable on the rotatable shaft; a plurality of rotor arms extending outwardly from the hub for pulverizing material received in the housing when the rotatable shaft is rotated, wherein the hub including a plurality of hub sections connectable together to form the hub, the hub sections being separable from each other and movable radially outwardly away from the rotatable shaft.

In at least one embodiment, the plurality of hub sections includes two hub sections.

In at least one embodiment, the hub sections are disconnectable from each other by moving the hub sections relative to each other in a direction parallel to an axis of the rotatable shaft.

In at least one embodiment, each hub section includes at least one hub section connector, each hub section connector being adapted to engage a corresponding hub section connector of another one of the hub sections.

In at least one embodiment, each hub section connector includes one of a male hub section connector and a female hub section connector.

In at least one embodiment, each hub section includes first and second hub section ends, the first hub section end including a male hub section connector and the second hub section end including a female hub section connector.

In at least one embodiment, the male and female hub section connectors form a dovetail connection.

In at least one embodiment, the male hub section connector includes a narrow base portion and a flared end portion extending away from the narrow base portion, the flared end portion being wider than the narrow base portion.

In at least one embodiment, the female hub section connector includes a narrow neck portion and a flared inner portion extending away from the narrow neck portion and into the corresponding hub section, the flared inner portion being wider than the narrow neck portion.

In at least one embodiment, the rotor hub includes upper and lower hub plates spaced apart from each other and extending substantially parallel to each other, and an annular core member coaxially engageable with the rotatable shaft and disposed between the upper and lower hub plates.

In at least one embodiment, a portion of the rotor arms is disposed between the upper and lower hub plates.

In at least one embodiment, the rotor hub further includes a plurality of plate spacers extending between the upper and lower hub plates.

In at least one embodiment, each plate spacer includes a cylindrical barrel extending perpendicularly to the upper and lower hub plates for receiving a fastener extending through the cylindrical barrel and through the upper and lower hub plates.

In at least one embodiment, the annular core member is substantially polygonal and defines a plurality of corners, the annular core member further including a plurality of fastener openings, each fastener opening being located at one of the corners of the annular core member.

In at least one embodiment, the annular core member is substantially octagonal.

In at least one embodiment, the annular core member includes a main body having top and bottom core member surfaces, a top circular projection extending away from the top core member surface and a bottom circular projection extending away from the bottom core member surface.

In at least one embodiment, the top and bottom core member surfaces are substantially planar and extend substantially parallel to each other.

In at least one embodiment, the upper hub plate has a central plate opening, the upper hub plate being receivable on the top core member surface such that the top circular projection is received in the central plate opening of the upper hub plate.

In at least one embodiment, the central plate opening of the upper hub plate has a diameter which is substantially equal to an outer diameter of the top circular projection such that the top circular projection snuggly fits in the central plate opening of the upper hub plate.

In at least one embodiment, the lower hub plate has a central plate opening, the lower hub plate being receivable on the bottom core member surface such that the bottom circular projection is received in the central plate opening of the lower hub plate.

In at least one embodiment, the central plate opening of the lower hub plate has a diameter which is substantially equal to an outer diameter of the bottom circular projection such that the bottom circular projection snuggly fits in the central plate opening of the lower hub plate.

In at least one embodiment, the rotor hub further includes top and bottom retaining rings coaxially engaging the rotatable shaft and positioned on either side of the upper and lower hub plates.

In at least one embodiment, each one of the top and bottom retaining rings is substantially flat and has an inner diameter substantially equal to a diameter of the rotatable shaft.

In at least one embodiment, the top retaining ring has an outer diameter greater than an outer diameter of the top circular projection of the annular core member so as to overlap both the top circular projection and the upper hub plate when in abutment with the upper hub plate.

In at least one embodiment, the bottom retaining ring has an outer diameter greater than an outer diameter of the bottom circular projection of the annular core member so as to overlap both the bottom circular projection and the lower hub plate when in abutment with the lower hub plate.

In at least one embodiment, the top retaining ring includes a first plurality of fastener-receiving openings and the bottom retaining ring includes a second plurality of fastener-receiving openings alignable with the first plurality of fastener-receiving openings to allow the top and bottom retaining rings to be connected together using a plurality of fasteners engaging corresponding fastener-receiving openings of the first and second pluralities of fastener-receiving openings and corresponding fastener openings of the annular core member.

In at least one embodiment, the pulverizer further comprises a hub locking member selectively engageable with the rotor hub to secure the rotor hub at a desired axial location along the rotatable shaft.

In at least one embodiment, the locking member includes a ring member coaxially engageable with the rotatable shaft, the ring member being engageable with both the hub and the rotatable shaft to prevent movement of the hub relative to the rotatable shaft.

In at least one embodiment, the ring member includes an annular wall having top and bottom ends and a top flange located at the top end, the annular wall being wedgeable between the hub and the rotatable shaft to prevent movement of the hub relative to the rotatable shaft.

In at least one embodiment, the annular wall has a cylindrical inner surface for engaging the rotatable shaft.

In at least one embodiment, the ring member is penannular and includes first and second ring ends which are spaced apart from each other.

In at least one embodiment, the ring member is substantially resilient to allow movement of the first and second ring ends towards each other.

In at least one embodiment, the annular wall has a tapered outer surface slidable against a corresponding angled inner surface of the hub when the ring member is moved along the rotatable shaft and towards the hub to move the first and second ring ends towards each other

### BRIEF DESCRIPTION OF THE DRAWINGS

FIG. 1 is a top perspective view of a pulverizer, in accordance with one embodiment;

FIG. 2 is a cutaway view of the pulverizer illustrated in FIG. 1;

FIG. 3 is a top perspective view of a rotatable assembly for the pulverizer illustrated in FIG. 1, shown in isolation;

FIG. 4 is a top perspective view of a pulverizing rotor assembly for the rotatable assembly illustrated in FIG. 3;

FIG. 5 is a bottom perspective view of the pulverizing rotor assembly illustrated in FIG. 4;

FIG. 6 is a top perspective view of the pulverizing rotor assembly illustrated in FIG. 4, showing the pulverizing rotor assembly with the top liner layer removed;

FIG. 7 is a top perspective view of the pulverizing rotor assembly illustrated in FIG. 4, showing the pulverizing rotor assembly with the top liner layer, the top retaining ring and one of the plate sections of the upper hub plate removed;

FIG. 8 is an elevation cross-sectional view of the pulverizing rotor assembly illustrated in FIG. 4, showing the pulverizing rotor assembly mounted to the rotatable shaft;

FIG. 9 is an exploded cross-sectional view of the pulverizing rotor assembly illustrated in FIG. 4;

FIG. 10A is a top perspective view of an annular core member for the pulverizing rotor assembly illustrated in FIG. 4;

FIG. 10B is a top plan view of the annular core member illustrated in FIG. 10A;

FIG. 10C is an elevation cross-sectional view of the annular core member illustrated in FIG. 10A;

FIG. 11A is a top perspective view of a hub locking member for the pulverizing rotor assembly illustrated in FIG. 4;

FIG. 11B is a top plan view of the hub locking member illustrated in FIG. 11A; and

FIG. 11C is a side elevation view of the hub locking member illustrated in FIG. 11A.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

For the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, it will be appreciated that positional descriptions such as “above”, “below”, “top”, “bottom”, “forward”, “rearward” “left”, “right” and the like should, unless otherwise indicated, be taken in the context of the figures and correspond to the position and orientation in the pulverizer and corresponding parts when being used. Positional descriptions should not be considered limiting.

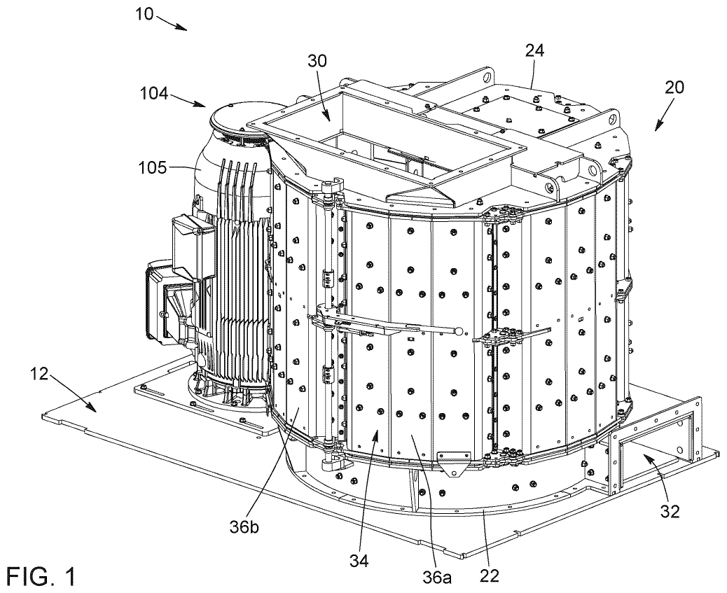

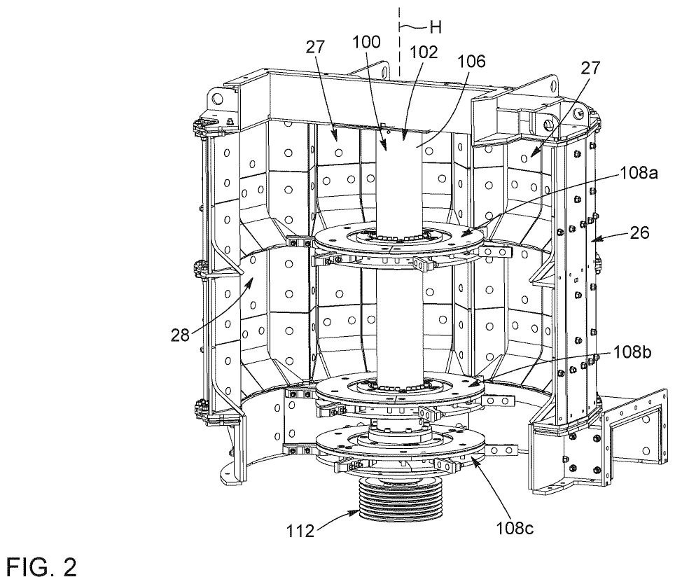

Referring now to FIGS. 1 and 2, there is shown a pulverizer 10, in accordance with one embodiment. The pulverizer 10 is adapted to receive an input material and to pulverize or comminute the input material.

It will be understood that the terms “pulverize”, “pulverization”, “comminute” and “comminution” are used herein to refer to a reduction in size of the particles in the input material.

The input material could be completely solid or at least partially solid. Specifically, the input material could include waste, glass, compost, wood, asphalt, singles, plastic, rocks, ore, minerals, cement, ceramics, metal pieces or any other material which may be pulverizable.

In the illustrated embodiment, the pulverizer 10 includes a base 12 and a housing 20 mounted over the base 12. Specifically, the housing 20 includes a bottom end 22 connected to the base 12 and a top end 24 opposite the bottom end 22. The housing 20 is hollow and includes a housing sidewall 26 extending between the top and bottom ends 24, 22 to define an interior chamber 28 in which the pulverization occurs. Specifically, the housing 20 includes an inlet 30 located at the top end 24 to receive the input material and an outlet 32 located at the bottom end 22 through which the pulverized material may be discharged once having been pulverized in the interior chamber 28. In the illustrated embodiment, the outlet 32 allows pulverized material to be discharged in a tangential direction to the housing sidewall 26. It will be understood that the outlet 32 may be configured differently. For example, the outlet 32 may be located in a bottom face of the housing 20 such that the pulverized material may be discharged in an axial direction downwardly from the housing 20. It will also be understood that alternatively, the outlet 32 may not be positioned exactly at the bottom end 22 of the housing 20 and may be positioned generally towards the bottom end 22. Similarly, the inlet 30 may not be positioned exactly at the upper end 24 of the housing 20 and may instead be located generally towards the upper end 24.

As shown in FIG. 2, in the illustrated embodiment, the housing 20 is generally cylindrical and defines a central housing axis H which extends between the top and bottom ends 24, 22 of the housing 20. The housing 20 is adapted to be disposed such that the central housing axis H extends substantially vertically when the pulverizer 10 is in operation. In this configuration, the input material fed into the inlet 30 will ultimately tend to fall down towards the outlet 32 by gravity.

In the illustrated embodiment, the housing sidewall 26, instead of being made from a single, unitary cylindrical body, includes a plurality of wall sections 27 which extend substantially between the top and bottom ends 24, 22 of the housing 20 and which are disposed side-by-side to form the housing sidewall 26. Alternatively, the housing sidewall 26 could instead be made of a single, unitary, substantially cylindrical body.

Still in the illustrated embodiment, the housing 20 further includes an access door 34 defined in the housing sidewall 26. The access door 34 is closed during operation of the pulverizer 10 and can be opened to allow access into the interior chamber 28. In the illustrated embodiment, the access door 34 includes first and second door panels 36a, 36b which are hingeably connected to the housing sidewall 26. Alternatively, the access door 34 could include a single door panel, or could be configured according to any other suitable configuration.

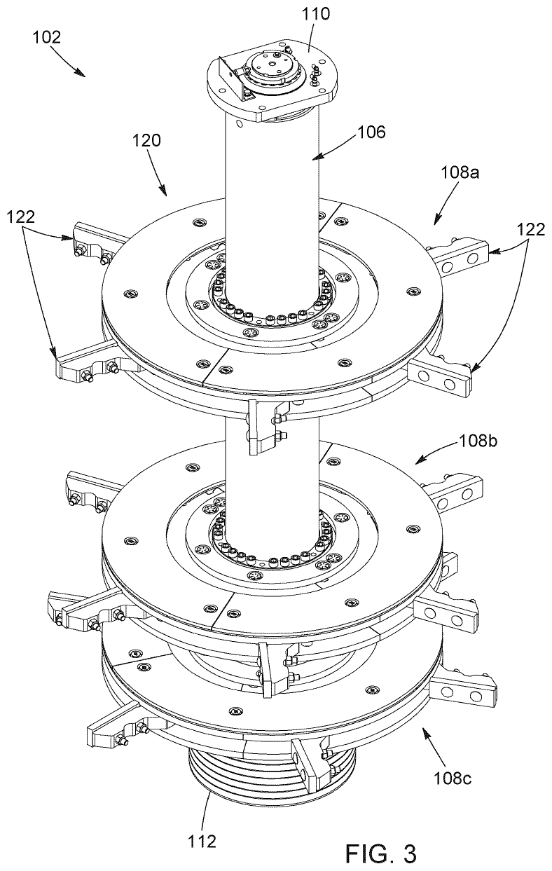

Referring now to FIGS. 2 and 3, the pulverizer 10 further comprises a rotatable assembly 102 disposed within the interior chamber 28 and a rotary actuator 104 operatively coupled to the rotatable assembly 102 for rotating the rotatable assembly 102 in order to generate an airflow within the housing 20. Specifically, the rotatable assembly 102 includes a rotatable shaft 106 located in the interior chamber 28 and extending between the top and bottom ends 24, 22 of the housing 20, along the central housing axis H, and a plurality of pulverizing rotor assemblies 108a, 108b, 108c secured to the rotatable shaft 106 so as to rotate about the central housing axis H when the rotatable shaft 106 is rotated.

In the illustrated embodiment, the pulverizing rotor assemblies 108a, 108b, 108c include a lower rotor assembly 108c located towards the bottom end 22 of the housing 20, proximal the outlet 32, and two upper rotor assemblies 108a, 108b spaced from each other and located above the lower rotor assembly 108c. Alternatively, the rotatable assembly 102 could instead include more or less than three pulverizing rotor assemblies.

Each pulverizing rotor assembly 108a, 108b, 108c includes a rotor hub 120 and a plurality of rotor arms 122 extending outwardly from the rotor hub 120 and towards the housing sidewall 26. The rotatable shaft 106 extends through the rotor hub 120 such that the rotor arms 122 are disposed in an arm rotation plane which extends orthogonally through the central housing axis H. In this configuration, when the rotatable shaft 106 is rotated, the rotor arms 122 therefore remain in the arm rotation plane and move along the arm rotation plane. Alternatively, instead of all being disposed in a rotation plane, the rotor arms 122 could instead be angled upwardly or downwardly relative to the rotatable shaft 106. In yet another embodiment, the rotor arms 122 could instead be pivotably connected to the rotatable shaft 106 such that the rotor arms 122 could selectively be angled upwardly and downwardly as desired, either manually or automatically using one or more arm actuators.

In the illustrated embodiment, the rotatable shaft 106 includes a top end 110 connected to the top end 24 of the housing 20 and a bottom end 112 located towards the bottom end 22 of the housing 20. The rotatable shaft 106 may be mounted to the housing 20 via bearings located at the top and bottom ends 24, 22 of the housing 20 to maintain the rotatable shaft 106 in alignment with the central housing axis H while allowing the rotatable shaft 106 to rotate relative to the central housing axis H.

It will be understood that according to this configuration, removing the rotor assemblies 108a, 108b, 108c by sliding it along the rotatable shaft 106 towards its top end 110 would necessitate the removal of the top end 24 of the housing 20, which would be relatively complex and time-consuming. This would also require one or more worker to climb up an elevated structure to reach the top end 24 of the housing 20, which may be inconvenient and/or potentially lead to injuries. This may also necessitate the rotatable shaft 106 to be realigned or balanced once the top end 24 is removed and placed back on the top end 110 of the rotatable shaft 106.

Instead, in the illustrated embodiment, the rotor assemblies 108a, 108b, 108c or at least a portion of the rotor assemblies 108a, 108b, 108c are removable from the rotatable shaft 106 laterally. In other words, the rotor assemblies 108a, 108b, 108c or one or more portions of the rotor assemblies 108a, 108b, 108c may be moved radially outwardly away from the rotatable shaft 106 and generally towards the housing sidewall 26.

This configuration allows the rotor assemblies 108a, 108b, 108c to be accessed through the access door 34 and for the rotor assemblies 108a, 108b, 108c or for at least a portion of the rotor assemblies 108a, 108b, 108c to be removed from the housing through the access door 34. In another embodiment, the housing 20 may not comprise an access door 34. In this embodiment, the rotor assemblies 108a, 108b, 108c to be accessed could instead be accessed by removing one or more of the wall sections 27 of the housing sidewall 26.

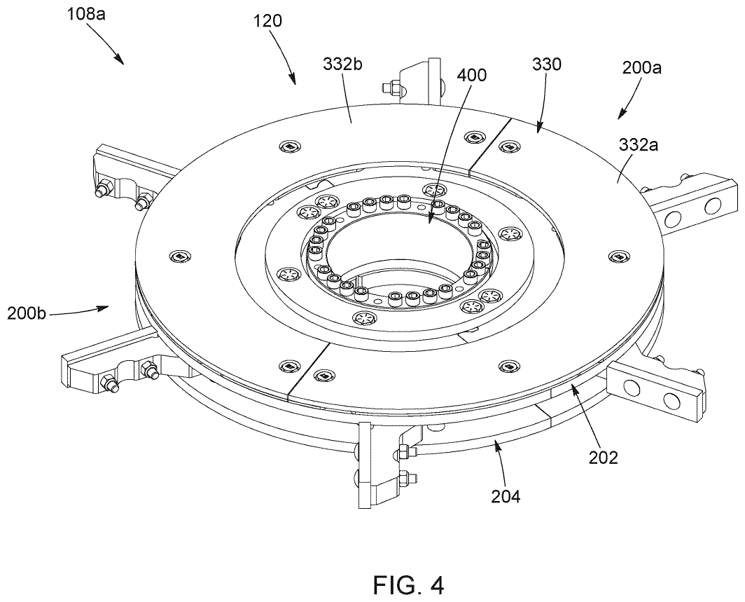

Turning to FIGS. 4 to 7, the rotor assemblies 108a, 108b, 108c will now be described using specifically to the rotor assembly 108a as reference. It will however be understood that the rotor assemblies 108a, 108b, 108c are configured substantially similarly to each other and therefore that the following description could apply interchangeably to any of the other rotor assemblies 108b, 108c.

In the illustrated embodiment, the rotor hub 120 is not made of a single, unitary piece. Instead, the rotor hub 120 includes a plurality of hub portions 200a, 200b which are separate from each other and which are connectable together to form the rotor hub 120. The hub portions 200a, 200b are further disconnectable from each other to allow the hub portions 200a, 200b to be removed laterally from the rotatable shaft 106. In the illustrated embodiment, the rotor hub 120 includes first and second hub portions 200a, 200b. Alternatively, the rotor hub 120 could include more than two hub portions 120.

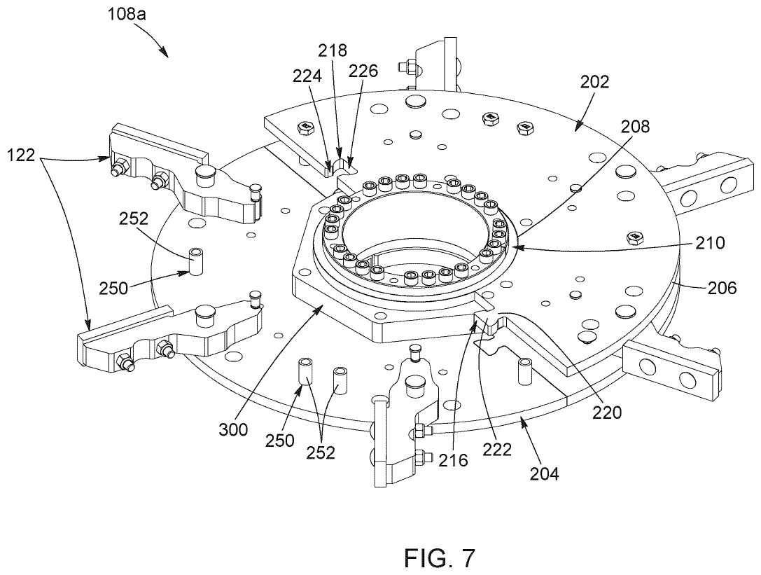

In the illustrated embodiment, the rotor hub 120 includes upper and lower hub plates 202, 204 which are spaced apart from each other and extend substantially parallel to each other, and an annular core member 300, shown in FIG. 7, which coaxially engages the rotatable shaft 106 and is disposed between the upper and lower hub plates 202, 204. The rotor arms 122 are further sandwiched between the hub plates 202, 204 and are connected to the rotor hub 120 via fasteners or pins extending trough the rotor arms 122 and through at least one of the upper and lower hub plates 202, 204.

Each hub plate 202, 204 is substantially annular and includes a circular outer edge 206 and a circular inner edge 208 defining a central plate opening 210. In the illustrated embodiment, the central plate opening 210 is substantially larger than the diameter of the rotatable shaft 106 such that the hub plates 202, 204 do not directly engage the rotatable shaft 106, as will be explained further below.

In the illustrated embodiment, the rotor hub 120 further includes a plurality of plate spacers 250 extending between the upper and lower hub plates 202, 204. The plate spacers 250 further contribute to maintaining the upper and lower hub plates 202, 204 substantially parallel to each other. Specifically, each plate spacer 250 includes a cylindrical barrel 252 which extends perpendicularly to the upper and lower hub plates 202, 204. The cylindrical barrel 252 is hollow and is adapted to receive a fastener extending through the cylindrical barrel 252 and through the upper and lower hub plates 202, 204. Alternatively, the plate spacers 250 may not include cylindrical barrels and may instead be configured according to any other suitable configuration.

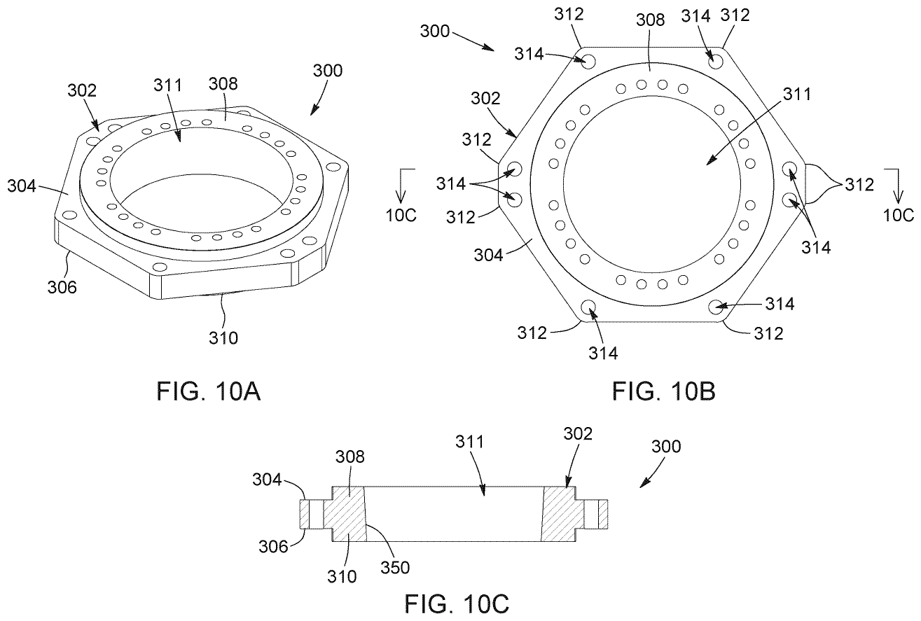

Referring to FIGS. 10A to 10C, the annular core member 300 includes a main body 302 having top and bottom core member surfaces 304, 306 which are substantially planar and which extend substantially parallel to each other. The annular core member 300 further includes a top circular projection 308 which extends away from the top core member surface 304 and a bottom circular projection 310 which extends away from the bottom core member surface 306. The top and bottom circular projections 308, 310 define rims of a central core member bore 311 extending through the annular core member between the top and bottom core members surfaces 304, 306.

In the illustrated embodiment, the main body 302 is substantially octagonal and has eight corners 312. The main body 302 further includes eight fastener openings 314, each fastener opening 314 being located at one of the eight corners 312. Alternatively, the annular core member 300 could instead be circular, rectangular or have any other suitable shape.

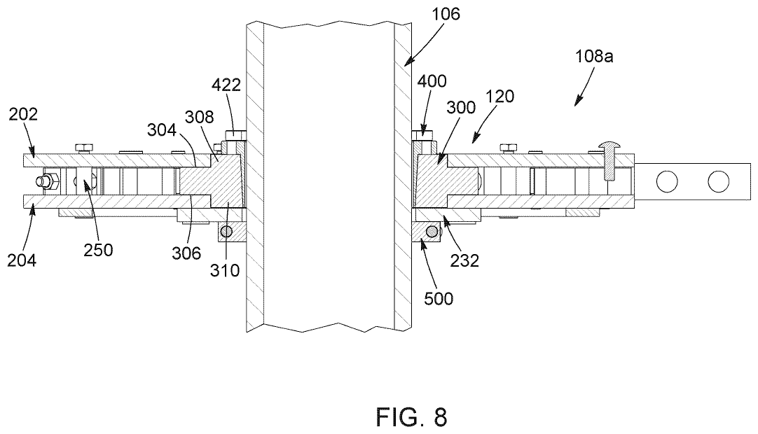

As shown in FIG. 8, when the upper and lower hub plates 202, 204 engage the annular core member 300, the upper hub plate 202 is received on the top core member surface 304 and the top circular projection 308 is received in the central plate opening 210 of the upper hub plate 202. Specifically, the top circular projection 308 has a diameter which is substantially equal to the diameter of the central plate opening 210 such that the top circular projection 308 fits substantially snuggly in the central plate opening 210. In the illustrated embodiment, the top circular projection 308 also has a height which is substantially equal to a thickness of the upper hub plate 202 such that the top circular projection 308 is flush with the upper hub plate 202.

Similarly, the lower hub plate 204 is received on the bottom core member surface 306 and the bottom circular projection 310 is received in the central plate opening 210 of the lower hub plate 204. The bottom circular projection 310 has a diameter which is substantially equal to the diameter of the central plate opening 210, and the bottom circular projection 310 also has a height which is substantially equal to a thickness of the lower hub plate 204.

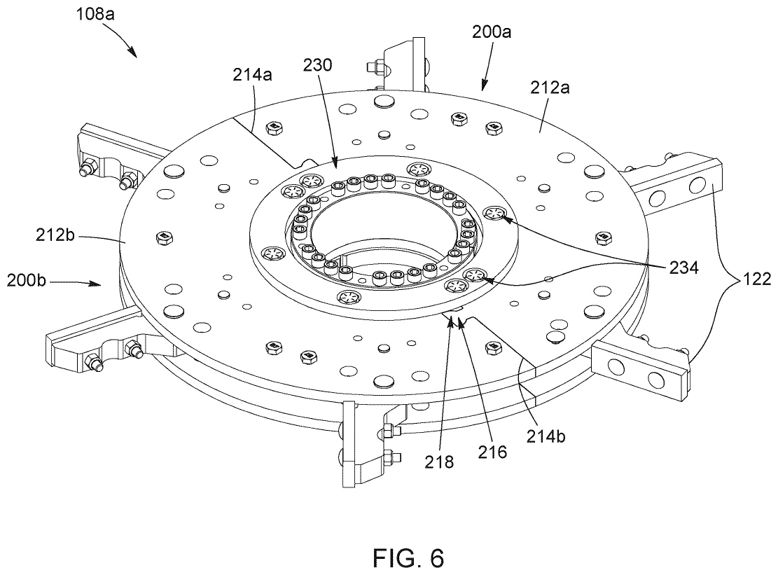

Referring now to FIGS. 6 and 7, in the illustrated embodiment, each one of the upper and lower hub plates 202, 204 includes first and second plate sections 212a, 212b which are connectable together to form the corresponding upper or lower hub plate 202, 204. In this configuration, each plate section 212a, 212b defines one of the hub portions 200a, 200b. Specifically, each plate section 212a, 212b is substantially semi-circular and includes first and second plate sections ends 214a, 214b located opposite each other. When the upper and lower hub plates 202, 204 are connected together, the first and second plate sections ends 214a, 214b of the first plate section 212a are connected to corresponding ones of the first and second plate sections ends 214a, 214b of the second plate section 212b.

Each plate section 212a, 212b further includes a pair of hub section connectors 216, 218, each hub section connector 216, 218 being connectable with a corresponding connector of the other plate section 212a, 212b. More specifically, each plate section 212a, 212b includes a male connector 216 located at the first plate section end 214a and a female connector 218 located at the second plate section end 214b. The male connector 216 is connectable to the female connector 218 of the other plate section 212a, 212b and the female connector 218 is connectable to the male connector 216 of the other plate section 212a, 212b. Alternatively, one of the first and second plate sections 212a, 212b could include two male connectors and the other one of the first and second plate sections 212a, 212b could include two female connectors. In another embodiment, instead of male/female connectors, the hub section connectors could include any other suitable connector.

As best shown in FIG. 7, in the illustrated embodiment, the connectors 216, 218 engage each other in a dovetail-type connection. Specifically, the male connector 216 extends away from the first plate section end 214a and includes a narrow base portion 220 and a flared end portion 222 which extends away from the narrow base portion 220. The female connector 218 includes a similarly-shaped indentation comprising a narrow neck portion 224 and a flared inner portion 226 extending away from the narrow neck portion 224 and into the corresponding plate section 212a, 212b. It will be understood that in this configuration, the flared end portion 222 of the male connector is wider than the narrow base portion 220 and the flared inner portion 226 of the female connector 218 is wider than the narrow neck portion 224. This configuration prevents the plate sections 212a, 212b from moving away from each other horizontally when connected. To disconnect the male connectors 216 from the female connectors 218, the plate sections 212a, 212b must be moved away from each other, i.e. upwardly or downwardly. Alternatively, the male and female connectors 216, 218 could instead be hook-shaped or have any other suitable configuration.

Referring now to FIGS. 6 and 8, in the illustrated embodiment, the rotor hub 120 further includes top and bottom retaining rings 230, 232 coaxially engaging the rotatable shaft 106 and positioned on either side of the upper and lower hub plates 202, 204. Each retaining ring 230, 232 is substantially flat and has an inner diameter which is substantially equal to the diameter of the rotatable shaft 106. Moreover, the top retaining ring 230 has an outer diameter which is greater than an outer diameter of the top circular projection 308 of the annular core member 300 so as to overlap both the top circular projection 308 and the upper hub plate 202 when in abutment with the upper hub plate 202. Similarly, the bottom retaining ring 232 has an outer diameter which is greater than an outer diameter of the bottom circular projection 310 of the annular core member 300 so as to overlap both the bottom circular projection 310 and the lower hub plate 204 when in abutment with the lower hub plate 204.

The top and bottom retaining rings 230, 232 further include a plurality of fastener-receiving openings 234 which are positioned on each retaining ring 230, 232 so as to be vertically alignable with corresponding fastener-receiving openings 234 in the other one of the retaining rings 230, 232. More specifically, the top and bottom retaining rings 230, 232 are connectable together using elongated fasteners extending through corresponding fastener-receiving openings 234 of the top and bottom retaining rings 230, 232 and through corresponding fastener openings 314 of the annular core member 300.

When the rotor hub 120 is assembled, the plate sections 212a, 212b of the upper hub plate 202 are connected together and the plate sections 212a, 212b of the lower hub plate 204 are connected together, the upper and lower hub plate 202, 204 engage the annular core member 300 and the top and bottom retaining rings 230, 232 are fastened together through the annular core member 300. In this configuration, the plate sections 212a, 212b of the upper hub plate 202 are held between the top retaining ring 230 and the annular core member 300 and are therefore prevented from being disconnected from each other. Similarly, the plate sections 212a, 212b of the lower hub plate 204 are held between the bottom retaining ring 232 and the annular core member 300 and are therefore prevented from being disconnected from each other.

Referring back to FIG. 4, in the illustrated embodiment, the rotor assembly 108a further includes a top liner layer 330 located over the upper hub plate 202. The top liner layer 330 is provided to cover and protect the fasteners extending through the plate spacers 250 from wear and damage and may prevent pulverized matter from accumulating on or around the fastener's head, which could make the fasteners harder to remove. Specifically, in the illustrated embodiment, the top liner layer 330 includes first and second liner layer panels 332a, 332b which are both semi-circular and which together form an annular configuration. Providing the top liner layer 330 in two separate liner layer panels 332a, 332b allows the liner layer panels 332a, 332b to be moved laterally from the rotatable shaft 106 once unfastened from the upper hub plate 202. Alternatively, the top liner layer 330 could include more than two liner panels, or a single liner panel which could be removed by moving it upwardly along the rotatable shaft 106.

Referring now to FIGS. 8, 9 and 11A to 11C, in the illustrated embodiment, the rotor assembly 108a further includes a hub locking member 400 which can engage the rotor hub 120 to secure the rotor hub 120 at a desired axial location along the rotatable shaft 106. More specifically, the hub locking member 400 includes a ring member 402 which is located towards the upper end of the rotatable shaft 106 and which coaxially engages the rotatable shaft 106. The ring member 402 is engageable with both the rotor hub 120 and the rotatable shaft 106 to prevent movement of the hub 120 relative to the rotatable shaft 106. Specifically, in the illustrated embodiment, the ring member 402 is configured to prevent both axial movement and rotation of the rotor hub 120 relative to the rotatable shaft 106.

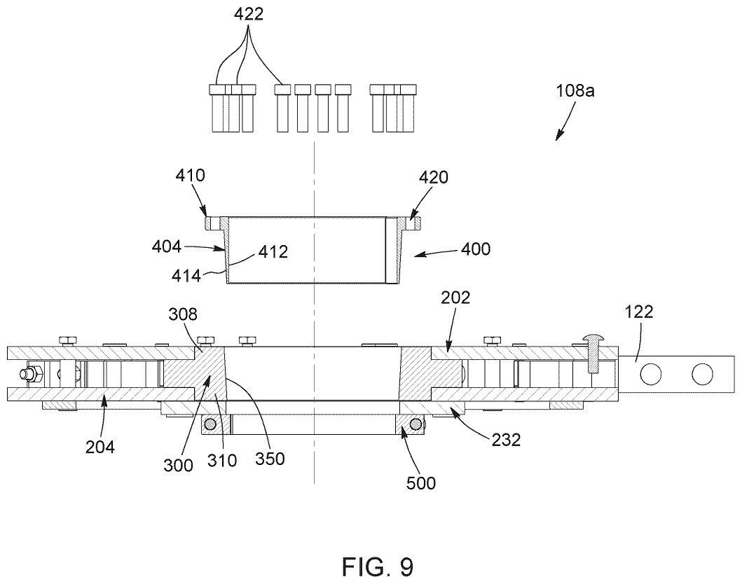

In the illustrated embodiment, the ring member 402 is configured to be wedged between the rotor hub 120 and the rotatable shaft 106. Specifically, the ring member 402 includes an annular wall 404 which extends between top and bottom annular wall ends 406, 408 and a top flange 410 located at the top annular wall end 406. As best shown in FIGS. 8 and 9, the annular wall 404 includes inner and outer surfaces 412, 414 extending opposite each other and extending between the top and bottom annular wall ends 406, 408. The inner surface 412 is substantially cylindrical to extend against and engage the rotatable shaft 106, while the outer surface 414 includes one or more angled surface configured for engaging similarly-angled corresponding surfaces defined on the rotor hub 120. More specifically, in the illustrated embodiment, the outer surface 414 is tapered along its entire circumference at a taper angle. Still in the illustrated embodiment, the annular core member 300 further includes a bore side surface 350 which extends around the central core member bore 311 and which is also tapered at the same taper angle as the outer surface 414 of the annular wall 404.

Alternatively, instead of being fully tapered, the outer surface 414 could include one or more angled portions and one or more non-angled portions. In this embodiment, the bore side surface 350 could also include one or more corresponding angled portions for engaging the one or more angled portions of the annular wall 404.

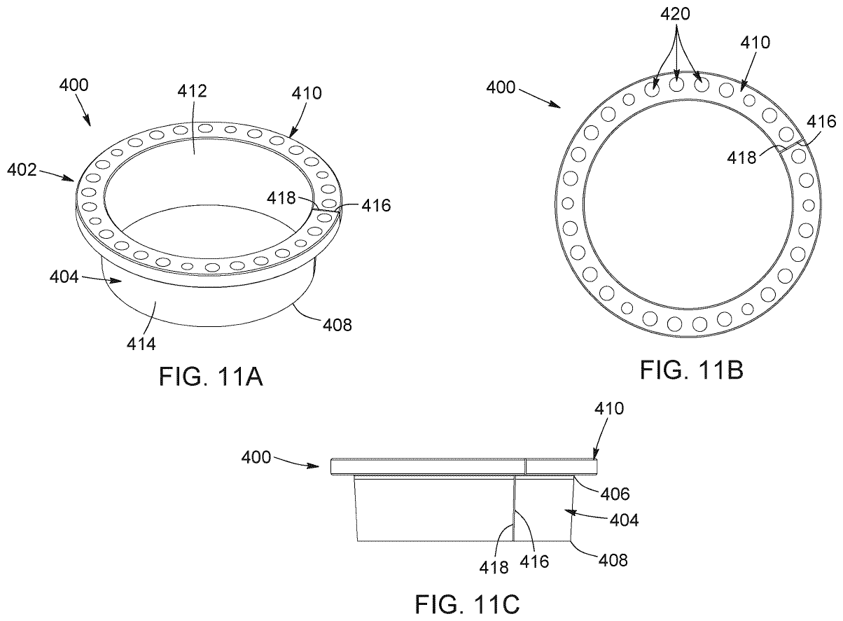

As best shown in FIGS. 11B and 11C, in the illustrated embodiment, the ring member 402 is penannular and includes first and second ring ends 416, 418 which face each other and which are spaced from each other. Moreover, the ring member 402 is further substantially resilient such that the ring member 402 can be deformed to move the first and second ring ends 416, 418 towards each other.

Specifically, the ring member 402 is configured such that when the ring member 402 coaxially engages the rotatable shaft 106 and is located above the annular core member 300, lowering the ring member 402 towards the annular core member 300 causes the outer surface 414 of the annular wall 404 to slide against the bore side surface 350 and to reduce a diameter of the ring member 402. This tightens the ring member 402 around the rotatable shaft 106 which increases friction between the annular wall 404 and the rotatable shaft 106 to substantially prevent movement of the ring member 402 relative to the rotatable shaft 106.

In the illustrated embodiment, the top flange 410 further includes a plurality of fastener openings 420 for receiving fasteners 422 to secure the ring member 402 to the annular core member 300. Specifically, the fasteners 422 extend through the fastener openings 420 and through corresponding fastener openings 352 defined in the top circular projection 308 of the annular core member 300. In this configuration, tightening the fasteners 422 will urge the ring member 402 towards the annular core member 300 and thereby tighten the ring member 402 around the rotatable shaft 106.

In this embodiment, the ring member 402 therefore frictionally engages the rotatable shaft 106. In one embodiment, the ring member 402 could include a positioning element configured for cooperating with a corresponding positioning element defined on the rotatable shaft 106 at a predetermined position to substantially prevent axial movement and/or rotation of the ring member 402 relative to the rotatable shaft 106. For example, the ring member 402 could include a projection or a key extending radially inwardly and the rotatable shaft 106 could include a recess or keyway sized and shaped for receiving the projection or key. Alternatively, the ring member 402 and the rotatable shaft 106 could include different positioning elements or, in another embodiment, may not include any positioning elements. In yet another embodiment, the hub locking member 400 could instead threadably engage the annular core member 300, or engage the annular core member 300 according to any suitable configuration. In still another embodiment, the ring member 402 may not be penannular and may be configured according to any other suitable configuration. In yet another embodiment, the hub locking member 400 may not include a ring member and may instead include one or more wedge members that do not extend around the entire circumference of the rotatable shaft 106.

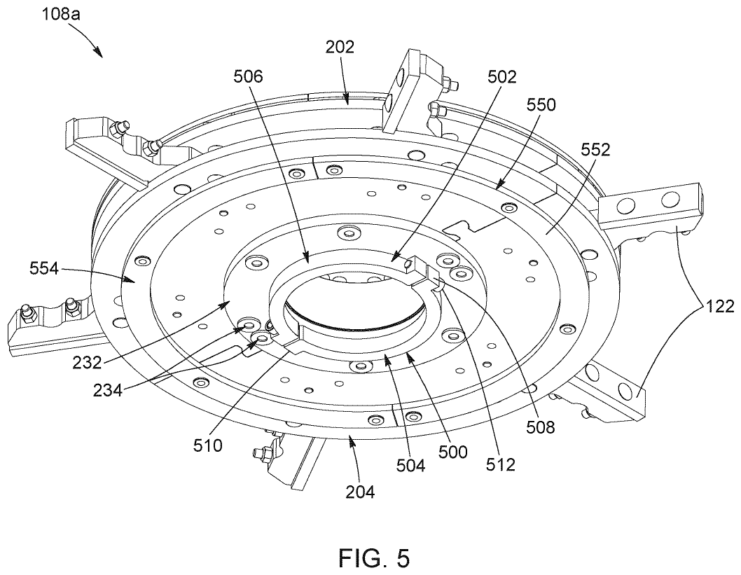

Referring now to FIGS. 5 and 8, in the illustrated embodiment, the rotor assembly 108a further includes a bottom holding member 500 coaxially engaging the rotatable shaft 106 below the lower hub plate 204. The bottom holding member 500 abuts the bottom retaining ring 232 and provides additional support to hold the plate sections 212a, 212b in connection with each other. The bottom holding member 500 further supports the rotor hub 120 when the hub locking member 400 is removed or is in a position in which it does not prevent movement of the rotor hub 120 relative to the rotatable shaft 106.

In the illustrated embodiment, the bottom holding member 500 includes a split collar 502 made of a plurality of collar members 504, 506 which are connectable together to form the split collar 502. Specifically, in the illustrated embodiment, the split collar 502 includes first and second collar members 504, 506 are substantially similar to each other. Specifically, each collar member 504, 506 is substantially semi-circular and extends between first and second collar member ends 508, 510. Each collar member end 508, 510 is configured to be positioned against a corresponding end 508, 510 of the other collar member 506 and to receive a fastener 512 extending through the corresponding ends 508, 510 of the collar members 504, 506 thereby forming the substantially circular split collar 502.

In one embodiment, the bottom holding member 500 engages the rotatable shaft 106 by friction. Specifically, when the fasteners 512 extending through the collar member ends 508, 510 are tightened, the collar members 504, 506 are moved towards each other and engage the rotatable shaft 106. In some embodiments, the first and second collar members could include an inner face configured to offer enhanced friction with the rotatable shaft 106.

Alternatively, the split collar 502 could be configured according to any other suitable configuration. For example, the split collar 502 could instead include a single penannular member having two free ends disposed adjacent each other, the two ends being configured to be moved towards each other by tightening a fastener engaging the two ends.

In another embodiment, the bottom holding member 500 could cooperate with a corresponding feature defined in the rotatable shaft 106 at a predetermined location. For example, the rotatable shaft 106 could include a groove and the split collar 502 could be sized and shaped to be receive in the groove to prevent movement of the split collar 502 in an axial direction along the rotatable shaft 106. Alternatively, the feature could include a projection extending radially outwardly from the rotatable shaft 106 which could abut an underside of the bottom holding member 500 or could engage a receiving recess defined in the bottom holding member 500, or any other feature that could contribute to locate the bottom holding member 500 at a desired axial location along the rotatable shaft 106 and/or maintain the bottom holding member 500 at the desired axial location.

Still in the illustrated embodiment, the rotor assembly 108a further includes an outer support ring 550 which has a larger diameter than the bottom retaining ring 232 and which is disposed concentrically around the bottom retaining ring 232 on the underside of the lower hub plate 204. The outer support ring 550 may contribute to preventing movement of the plate sections 212a, 212b of the lower hub plate 204 relative to each other in the axial direction and/or to maintain the plate sections 212a, 212b of the lower hub plate 204 in a horizontal plane. In the illustrated embodiment, the outer support ring 550 includes first and second support ring halves 552, 554 which are each semi-circular. Alternatively, the outer support ring 550 may be include a single continuous, circular piece, may include more than two pieces or may be configured according to any other suitable configuration. In another embodiment, the rotor assembly 108a may not include an outer support ring 550.

To disconnect the first and second hub portions 200a, 200b from each other, the top retaining ring 230 is first unfastened from the upper hub plate 202 and is slid upwardly along the rotatable shaft 106 and away from the upper hub plate 202.

Alternatively, the top retaining ring 230 could be made of a plurality of retaining ring sections which could be moved laterally away from the rotatable shaft 106.

The top liner layer 350 is also removed from the upper hub plate 202 by unfastening the liner layer panels 352a, 352b from the upper hub plate 202 and moving them laterally away from the rotatable shaft 106.

In one embodiment, the fasteners extending through the plate spacers 250 are then removed.

One of the plate sections 212a, 212b is then moved upwardly relative to the other one of the plate sections 212a, 212b, in a direction parallel to the axis of the rotatable shaft 106, thereby disengaging the connectors 216, 218 of the upper hub plate 202 from each other. The plate sections 212a, 212b can then be moved away from each other and away from the rotatable shaft 106 in a lateral direction.

In some circumstances, it may not be necessary or desired to remove both plate sections 212a, 212b of the upper hub plate 202. For example, it may be necessary to remove only the first plate section 212a to service or replace one of the rotor arms 122 located under the first plate section 212a.

In some circumstances, it may further be necessary or desirable to remove one or both of the plate sections 212a, 212b of the lower hub plate 204. In this case, the annular core member 300 could be removed by first removing the hub locking member 400 by unfastening the fasteners 422 and moving the hub locking member 400 upwardly along the rotatable shaft 106, and then moving the annular core member 300 upwardly along the rotatable shaft 106.

It will be understood that when the hub locking member 500 is removed, the lower hub plate 204 is supported by the bottom holding member 500 on which the bottom retaining ring 232 abuts.

The bottom retaining ring 232 and the outer support ring 550 can then be unfastened from the lower hub plate 204 and one of the plate sections 212a, 212b of the lower hub plate 204 and one of the plate sections 212a, 212b of the lower hub plate 204 can be moved upwardly to disengage the connectors 216, 218 of the lower hub plate 204 from each other. The plate sections 212a, 212b of the lower hub plate 204 can then be moved laterally away from each other.

In some circumstances, it may further be necessary or desirable to move one or more of the rotor assemblies 108a, 108b, 108c to another position along the rotatable shaft 106. In this case, the hub locking member 500 of the corresponding rotor assembly 108a, 108b, 108c may be removed by unfastening the fasteners 422 and moving the hub locking member 500 upwardly along the shaft 106. The bottom holding member 500 can then be unfastened to be movable relative to the shaft 106. The entire rotor hub 120 can then be moved along the shaft 106 at another desired location. The bottom holding member 500 can then be moved along the shaft 106 such that it abuts the bottom retaining ring 232 and be tightened around the shaft 106. The hub locking member 500 can then be lowered over the annular core member 300 and secured to the annular core member 300 to maintain the rotor hub 120 at the desired location.

It will be understood that the above method for removing at least a portion of the rotor hub 120 from the shaft 106 and to reposition the rotor hub 120 at another location along the shaft 106 is provided merely as an example and that various alternative methods may be used.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A rotor assembly for a pulverizer, the pulverizer including a housing and a rotatable shaft rotatably mounted in the housing, the rotor assembly comprising:
a hub mountable on the rotatable shaft;
a plurality of rotor arms extending outwardly from the hub for pulverizing material received in the housing when the rotatable shaft is rotated,
wherein the hub including a plurality of hub sections connectable together to form the hub, the plurality of hub sections being separable from each other and movable radially outwardly away from the rotatable shaft.

2. (canceled)

3. The rotor assembly of claim 1, wherein the plurality of hub sections are disconnectable from each other by moving the plurality of hub sections relative to each other in a direction parallel to an axis of the rotatable shaft.

4. The rotor assembly of claim 1, wherein each hub section includes at least one hub section connector, each hub section connector being adapted to engage a corresponding hub section connector of another one of the plurality of hub sections.

5. The rotor assembly as claimed in claim 4, wherein each hub section connector includes one of a male hub section connector and a female hub section connector.

6. The rotor assembly of claim 1,
wherein each hub section includes a first hub section end and a second hub section ends, the first hub section end including a male hub section connector and the second hub section end including a female hub section connector.

7. The rotor assembly of claim 6, wherein the male hub section connector and the female hub section connector form a dovetail connection, such that:
the male hub section connector includes a narrow base portion and a flared end portion extending away from the narrow base portion, the flared end portion being wider than the narrow base portion; and/or
the female hub section connector includes a narrow neck portion and a flared inner portion extending away from the narrow neck portion and into the corresponding hub section, the flared inner portion being wider than the narrow neck portion.

8. (canceled)

9. (canceled)

10. The rotor assembly of claim 1, wherein the rotor hub includes an upper hub plate and a lower hub plate spaced apart from each other and extending substantially parallel to each other, and an annular core member coaxially engageable with the rotatable shaft and disposed between the upper hub plate and the lower hub plate.

11. The rotor assembly of claim 10, wherein at least one of:
a portion of the rotor arms is disposed between the upper and lower hub plates;
the rotor hub further includes a plurality of plate spacers extending between the upper hub plate and the lower hub plate;
the annular core member is substantially polygonal and defines a plurality of corners, the annular core member further including a plurality of fastener openings, each fastener opening being located at one of the corners of the annular core member; and
the annular core member includes a main body having top and bottom core member surfaces, a top circular projection extending away from the top core member surface and a bottom circular projection extending away from the bottom core member surface.

12.-17. (canceled)

18. The rotor assembly of claim 11, wherein at least one of the upper hub plate and the lower hub plate has a central plate opening, and wherein the upper hub plate is receivable on the top core member surface such that the top circular projection is received in the central plate opening of the upper hub plate and/or the lower hub plate is receivable on the bottom core member surface such that the bottom circular projection is received in the central plate opening of the lower hub plate.

19. The rotor assembly of claim 18, wherein at least one of:
the central plate opening of the upper hub plate has a diameter which is substantially equal to an outer diameter of the top circular projection such that the top circular projection snuggly fits in the central plate opening of the upper hub plate; and
the central plate opening of the lower hub plate has a diameter which is substantially equal to an outer diameter of the bottom circular projection such that the bottom circular projection snuggly fits in the central plate opening of the lower hub plate.

20.-21. (canceled)

22. The rotor assembly of claim 11, wherein the rotor hub further includes a top retaining ring and a bottom retaining ring coaxially engaging the rotatable shaft and positioned on either side of the upper hub plate and the lower hub plate.

23. The rotor assembly of claim 22, wherein at least one of:
each one of the top and bottom retaining rings is substantially flat and has an inner diameter substantially equal to a diameter of the rotatable shaft;
the top retaining ring has an outer diameter greater than an outer diameter of the top circular projection of the annular core member so as to overlap both the top circular projection and the upper hub plate when in abutment with the upper hub plate;
the bottom retaining ring has an outer diameter greater than an outer diameter of the bottom circular projection of the annular core member so as to overlap both the bottom circular projection and the lower hub plate when in abutment with the lower hub plate; and
the top retaining ring includes a first plurality of fastener-receiving openings and the bottom retaining ring includes a second plurality of fastener-receiving openings alignable with the first plurality of fastener-receiving openings to allow the top and bottom retaining rings to be connected together using a plurality of fasteners engaging corresponding fastener-receiving openings of the first and second pluralities of fastener-receiving openings and corresponding fastener openings of the annular core member.

24.-26. (canceled)

27. The rotor assembly of claim 1, further comprising a hub locking member selectively engageable with the rotor hub to secure the rotor hub at a desired axial location along the rotatable shaft.

28. The rotor assembly of claim 27, wherein the hub locking member includes a ring member coaxially engageable with the rotatable shaft, the ring member being engageable with both the hub and the rotatable shaft to prevent movement of the hub relative to the rotatable shaft.

29. The rotor assembly of claim 28, wherein the ring member includes an annular wall having top and bottom ends and a top flange located at the top end, the annular wall being wedgeable between the hub and the rotatable shaft to prevent movement of the hub relative to the rotatable shaft.

30. (canceled)

31. The rotor assembly of claim 29, wherein the ring member is penannular and includes first and second ring ends which are spaced apart from each other.

32. The rotor assembly of claim 31, wherein at least one of:
the ring member is substantially resilient to allow movement of the first and second ring ends towards each other; and
the annular wall has a tapered outer surface slidable against a corresponding angled inner surface of the hub when the ring member is moved along the rotatable shaft and towards the hub to move the first and second ring ends towards each other.

33. (canceled)

34. A shaft assembly for a pulverizer, the pulverizer including a housing, the shaft assembly comprising:
a rotatable shaft rotatably mountable in the housing;
a hub mountable on the rotatable shaft;
a plurality of rotor arms extending outwardly from the hub for pulverizing material received in the housing when the rotatable shaft is rotated,
wherein the hub including a plurality of hub sections connectable together to form the hub, the plurality of hub sections being separable from each other and movable radially outwardly away from the rotatable shaft.

35. A pulverizer comprising:
a housing;
a rotatable shaft rotatably mountable in the housing;
a hub mountable on the rotatable shaft;
a plurality of rotor arms extending outwardly from the hub for pulverizing material received in the housing when the rotatable shaft is rotated,
wherein the hub including a plurality of hub sections connectable together to form the hub, the plurality of hub sections being separable from each other and movable radially outwardly away from the rotatable shaft.

36. (canceled)

37. The pulverizer of claim 35, wherein the plurality of hub sections are disconnectable from each other by moving the plurality of hub sections relative to each other in a direction parallel to an axis of the rotatable shaft.

38.-67. (canceled)
